(19) United States
(12) Patent Application Publication
(10) Pub. No.: US 2017/0106816 A1
(43) Pub. Date: Apr. 20, 2017

(54) BAND CLIP AND WIRE HARNESS

(71) Applicant: SUMITOMO WIRING SYSTEMS, LTD., Mie (JP)

(72) Inventors: Masataka WAKABAYASHI, Mie (JP); Minoru FUKUDA, Mie (JP)

(73) Assignee: SUMITOMO WIRING SYSTEMS, LTD., Mie (JP)

(21) Appl. No.: 15/274,171

(22) Filed: Sep. 23, 2016

(30) Foreign Application Priority Data
Oct. 14, 2015 (JP) 2015-202863

(51) Int. Cl. B60R 16/02; B65D 63/10

(52) U.S. Cl. CPC B60R 16/0215; B65D 63/1027; B65D 2563/108

(57) ABSTRACT

A band clip includes a binding band portion and a clip portion. The clip portion has a flange portion, a column portion, four inclined pieces inclined relative to the column portion, and a connecting piece connecting the column portion and each inclined piece. The clip portion is constituted of a shape memory resin and acquires a memorized shape such that a connecting distance between the column portion and each inclined piece becomes shorter than at normal temperature. When fitting the clip portion to a through hole, a second end portion near a vehicle body panel bends so that the inclined piece is locked to an edge of the through hole. When removing the clip portion from the through hole, a distance between a lower end portion of the inclined piece and a central axis of the column portion reaches a size that can pass through the through hole.

### CROSS-REFERENCE TO RELATED APPLICATIONS

The present application claims priority under 35 U.S.C. §119 of Japanese Application No. 2015-202863, filed on Oct. 14, 2015, the disclosure of which is expressly incorporated by reference herein in its entirety.

### BACKGROUND OF THE INVENTION

1. Field of the Invention

The present invention relates to a band clip locking to a vehicle body and a wire harness provided with the band clip.

2. Description of Related Art

Traditionally, a band clip that locks a group of electrical wires in a through hole of a vehicle body panel or the like includes a binding band portion that binds the group of electrical wires, and a clip portion that is integrally provided on a head of the binding band portion and is locked in the through hole of the vehicle body panel.

The clip portion includes a flange portion provided integrally with the head at a position separated from the head by a required distance, the flange portion abutting the vehicle body panel on a group of electrical wires-side of the vehicle body panel when the clip portion is locked in the through hole; a column portion provided on the flange portion and passing through the through hole; and an arm portion that is curved so that a first end portion is fixed to an upper end of the column portion and a second end portion is locked in the through hole when the clip portion is locked in the through hole.

Accordingly, the band clip locked in the vehicle body panel needs to be removed from the vehicle body panel when it becomes necessary to repair the vehicle body or exchange the wire harness, which requires an operation of removing the band clip using special tools to cut the column portion of the clip portion, for example. Cutting the column portion of the clip portion negatively impacts workability, causing damage or destruction of the band clip. Thus, this type of band clip does not meet an environmentally conscious requirement of being recycleable/reusable, as required of automobile parts in recent years.

In order to resolve the above-noted issues, Japanese Utility Model Publication No. H06-069557 proposes a structure of a band clip having a locking head 2 standing upright on a portion attaching to a wire harness, as illustrated in FIG. 6, in which the locking head 2 is fitted and locked in a through hole 9 of a vehicle body or machine. The locking head 2 is configured by a pair of elastic locking pieces 5A and 5B provided vertically from an upper end of a lock column 3 in an open-legged state the elastic locking pieces 5A and 5B having a stepped locking portion 6 on a lower end thereof. Lock releasing pieces 8A and 8B integral with, and extending in an opening direction of, the elastic locking pieces 5A and 5B are provided below the stepped locking portion 6 of the elastic locking pieces 5A and 5B, and exist on a wire harness-side of the through hole 9 when the locking head 2 is in a fitted position.

In the band clip disclosed in Japanese Utility Model Publication No. H06-069557, when the lock releasing pieces 8A and 8B provided to the lower end of the pair of elastic locking pieces 5A and 5B are pinched by fingers or a tool so as to move closer to each other, the stepped locking portion 6 that is engaged with the through hole 9 is removed therefrom, and the band clip can be pulled out of the through hole 9.

However, in the band clip disclosed in Japanese Utility Model Publication No. H06-069557, in order to pull the band clip out of the vehicle body panel it is necessary to move the lock releasing pieces 8A and 8B closer to each other with fingers or a tool, which requires human power. Thus, it is desirable to enhance workability of removal of the band clip by reducing labor.

### SUMMARY OF THE INVENTION

The present invention is conceived to solve the above-noted issues. The present invention provides a band clip and a wire harness having enhanced workability in removal from a vehicle body panel.

In order to achieve the above-noted objective, a band clip according to the present invention includes a binding band portion that binds a group of wires, and a clip portion integrally provided with a head of the binding band portion and locking in a through hole of a vehicle body panel. The clip portion includes a flange portion integrally provided with the head at a position separated from the head by a required distance, the flange portion abutting the vehicle body panel without passing through the through hole when the clip portion is locked in the through hole; a column portion provided on the flange portion and passing through the through hole when the clip portion is locked in the through hole; at least two inclined pieces inclined relative to the column portion such that a first end portion is fixed to an upper end of the column portion and a second end portion is locked in the through hole when the clip portion is locked in the through hole; and a connecting piece that connects a position of the column portion near the vehicle body panel and a position of each inclined piece near the vehicle body panel, where at least the connecting piece is constituted of a shape memory resin and acquires a memorized shape such that a connecting distance between the column portion and each inclined piece becomes shorter than at normal temperature. When fitting the clip portion to the through hole, the second end portion near the vehicle body panel bends so that the inclined pieces pass through the through hole and are locked to an edge of the through hole. When removing the clip portion from the through hole, the connecting piece is heated to a glass transition temperature and exhibits shape memory, and the connecting distance becomes shorter. Thereby, a distance between a lower end portion of the inclined piece and a central axis of the column portion reaches a size that can pass through the through hole.

According to this configuration, in the band clip according to the present invention, the connecting piece is heated to the glass transition temperature in a state where the inclined piece is fitted in the through hole of the vehicle body panel, and the connecting piece constituted of the shape memory resin exhibits shape memory and the connecting distance between the column portion and the inclined piece becomes shorter. As a result, the distance between the lower end portion of the inclined piece and the central axis of the column portion reaches a size that can pass through the through hole; thus, the band clip can be easily removed from the through hole of the vehicle body panel. Accordingly, workability of removing the band clip can be enhanced.

Additionally, in the band clip having the above-described configuration, the connecting piece can be curved in a “V” shape so as to protrude toward the flange portion.

According to this configuration, the V-shaped connecting piece is more easily deformed in a direction in which an interval between a first and second side of the connecting piece narrows, and the inclined piece can be easily displaced inwardly. Accordingly, the band clip can be easily pulled out of the through hole of the vehicle body panel and workability of removing the band clip can be enhanced.

A wire harness according to the present invention includes the group of wires and the above-described band clip, and is configured so that the group of wires is bound by the binding band portion.

According to this configuration, in the wire harness according to the present invention, the band clip can be easily pulled out of the through hole of the vehicle body panel. Accordingly, workability of removing the band clip can be enhanced.

According to the present invention, it is possible to provide the band clip and the wire harness having enhanced workability in removing the band clip from the vehicle body panel.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a perspective view of a wire harness according to an embodiment of the present invention;

FIG. 2 is a longitudinal section view of the wire harness according to the embodiment of the present invention;

FIGS. 3A and 3B are cross-sectional views of a state where a band clip according to an embodiment of the present invention is locked in a vehicle body panel;

FIGS. 4A, 4B, and 4C are cross-sectional views of the band clip according to the embodiment of the present invention in a state before it is locked in the vehicle body panel;

FIGS. 5A, 5B, and 5C are cross-sectional views of a state where the band clip according to the embodiment of the present invention is being removed from the vehicle body panel; and

FIG. 6 is a front view of a conventional band clip.

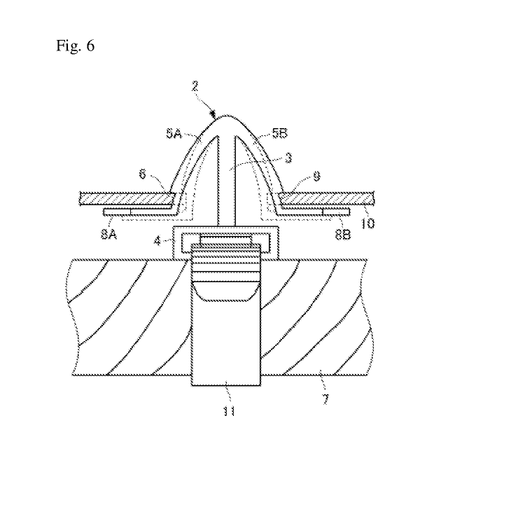

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the forms of the present invention may be embodied in practice.

In the following, an embodiment of the present invention is described with reference to the drawings.

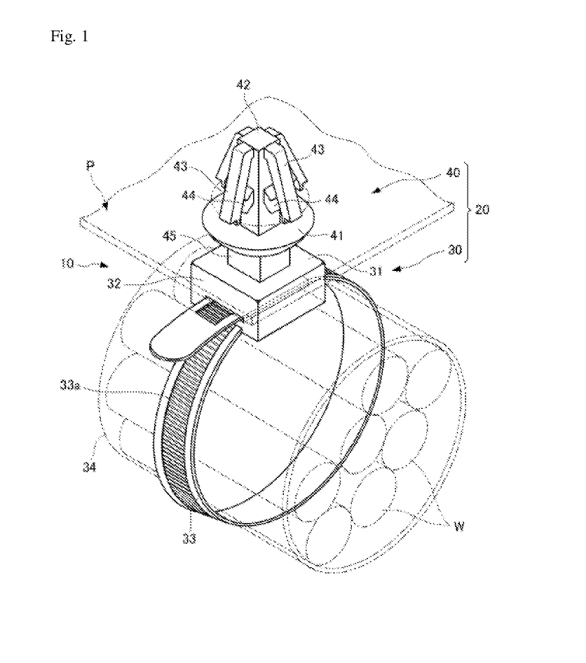

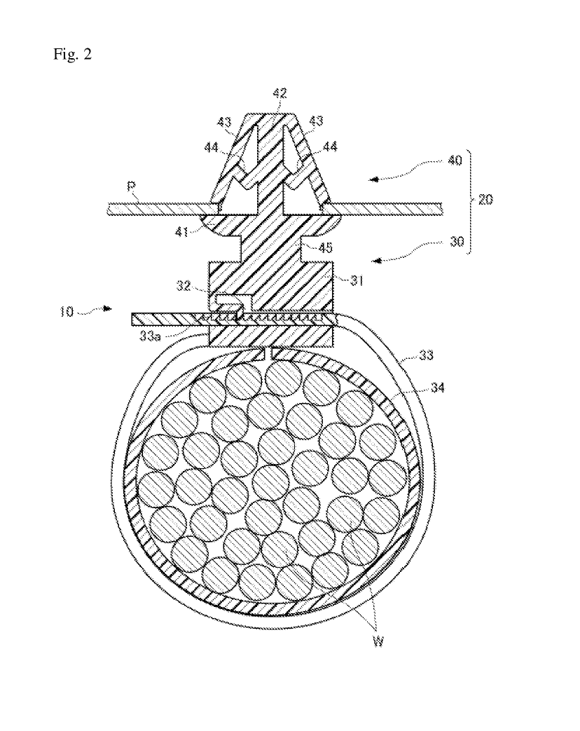

FIGS. 1 and 2 illustrate a band clip and a wire harness according to an embodiment of the present invention.

FIG. 1 is a perspective view of a wire harness 10 according to the present embodiment, and FIG. 2 is a longitudinal section view thereof. As illustrated in FIGS. 1 and 2, the wire harness 10 includes a group of wires W and a band clip 20, and is attached to a vehicle body panel P. The wire harness 10 is used to electrically connect electric components of electronic apparatuses and the like to vehicles such as automobiles. The group of wires W constitutes a plurality of electrical wires.

The band clip 20 includes a binding band portion 30 and a clip portion 40. The binding band portion 30 includes a head 31 and a band 33, and binds the group of wires W which is wound with a corrugated tube 34.

The head 31 is constituted of a rectangular parallelepiped resin and has a locking portion 32 in an interior thereof that fixates the band 33 at a desired position. The band 33 is made of a belt-like flexible resin and an uneven locked portion 33a is provided in a central portion thereof. A first end portion of the band 33 is fixed to the head 31 and a second end portion can move freely. The uneven locked portion 33a is locked together with the locking portion 32 so as to wrap around the group of wires W wound with the corrugated tube 34.

The clip portion 40 has a flange portion 41, a column portion 42, an inclined piece 43, a connecting piece 44, and a connecting column portion 45. The clip portion 40 is integrally provided on the head 31 of the binding band portion 30 and is locked in a through hole 50 of the vehicle body panel P. Although in the present embodiment the clip portion 40 is made of a shape memory resin, it is sufficient that at least the connecting piece 44 constituting the clip portion 40 be made of the shape memory resin.

The flange portion 41 is integrally provided with the head 31 at a position separated from the head 31 by a required distance, and when the clip portion 40 is locked in the through hole 50, the flange portion 41 abuts the vehicle body panel P without passing through the through hole 50. Thus, a diameter of the flange portion 41 is larger than a diameter of the through hole 50. While the flange portion 41 has a disk shape in the present embodiment, it can be a different shape as long as it is of a size that cannot pass through the through hole 50.

The connecting column portion 45 is a columnar resin member provided so as to connect the flange portion 41 and the head 31. By determining a height of the connecting column portion 45 according to a distance between the through hole 50 of the vehicle body panel P and the group of wires W, the flange portion 41 can be provided at the position separated from the head 31 by the required distance.

When the clip portion 40 is locked in the through hole 50 of the vehicle body panel P, the flange portion 41 abuts the vehicle body panel P from below and a second end portion 43b of the inclined piece 43 abuts the vehicle body panel P from above and from a side, thereby ensuring locking.

The column portion 42 is provided on the flange portion 41 and passes through the through hole 50 when the clip portion 40 is locked in the through hole 50. While the column portion 42 has a columnar rectangular parallelepiped shape in the present embodiment, it can be a different shape, such as a cylindrical shape.

The inclined piece 43 has a first end portion 43a fixed to an upper end of the column portion 42 and the second end portion 43b is inclined relative to the column portion 42 so as to lock in the through hole 50 when the clip portion 40 is locked in the through hole 50. The inclined piece 43 is provided to each side surface of the columnar shape (four in total). Although four inclined pieces 43 are provided in the present embodiment, so long as there are at least two, a number of the inclined piece 43 is not limited thereto. From a viewpoint of locking stability, it is preferable that the inclined pieces 43 be provided isotropically to the column portion 42.

The second end portion 43b is positioned on a lower end of the inclined piece 43 and constitutes a stepped locking portion having a stepped section. When the clip portion 40 is locked in the vehicle body panel P, the second end portion 43b abuts an edge of the through hole 50.

The connecting piece 44 connects a position A of the column portion 42 near the vehicle body panel P and a position B of each inclined piece 43 near the vehicle body panel P, and serves as a plate spring. The connecting piece 44 is constituted of the shape memory resin and acquires a memorized shape such that, when heated to a glass transition temperature, a connecting distance D1, being a horizontal distance between the column portion 42 and each inclined piece 43, the connecting piece 44 becomes shorter than at normal temperature.

The glass transition temperature as referred to herein is a temperature at which polymer molecules do not change their relative positions but main chains thereof begin or stop rotating or vibrating. By utilizing a characteristic of glass transitioning, shape memory resin used in the present embodiment is caused to shrink so that the memorized shape of the clip portion 40, including the connecting piece 44, shrinks in a horizontal direction compared to a shape of the clip portion 40 in a normal temperature state.

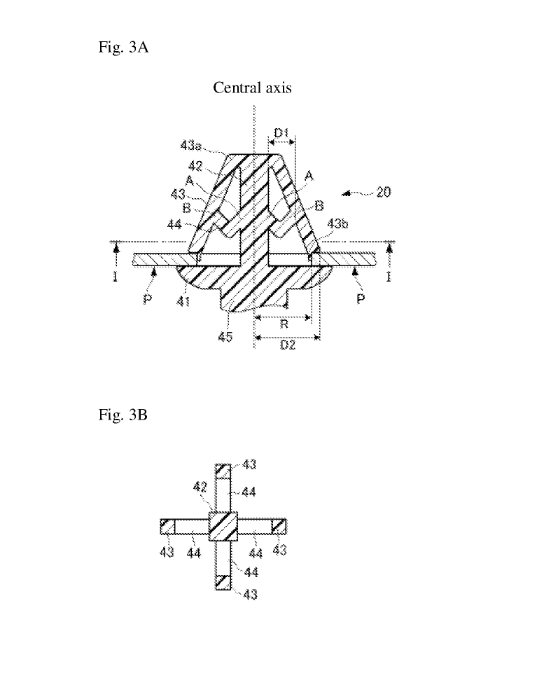

FIGS. 3A and 3B illustrate a state where the clip portion 40 is locked in the vehicle body panel P; FIG. 3A is a longitudinal section view and FIG. 3B is a top view of cross-section I of FIG. 3A. As illustrated in FIG. 3A, the connecting piece 44 is curved in a “V” shape so as to protrude toward the flange 41. Although in the present embodiment the connecting piece 44 has the shape which curves in the “V” shape so as to protrude toward the flange 41 as described above, the shape is not necessarily limited to this shape as long as the connecting distance between the column portion 42 and the inclined piece 43 becomes shorter when heated to the glass transition temperature, and a plurality of curved portions can be provided, for example.

In the state shown in FIG. 3A, an upper surface of the flange portion 41 abuts the vehicle body panel P in a vertical direction and the second end portion 43b abuts the vehicle body panel P in the vertical direction and the horizontal direction, thereby locking the clip portion 40 in the vehicle body panel P. Due to an elastic force in the vertical and horizontal directions acting on the vehicle body panel P from the second end portion 43b in this state, the clip portion 40 is securely locked in the vehicle body panel P.

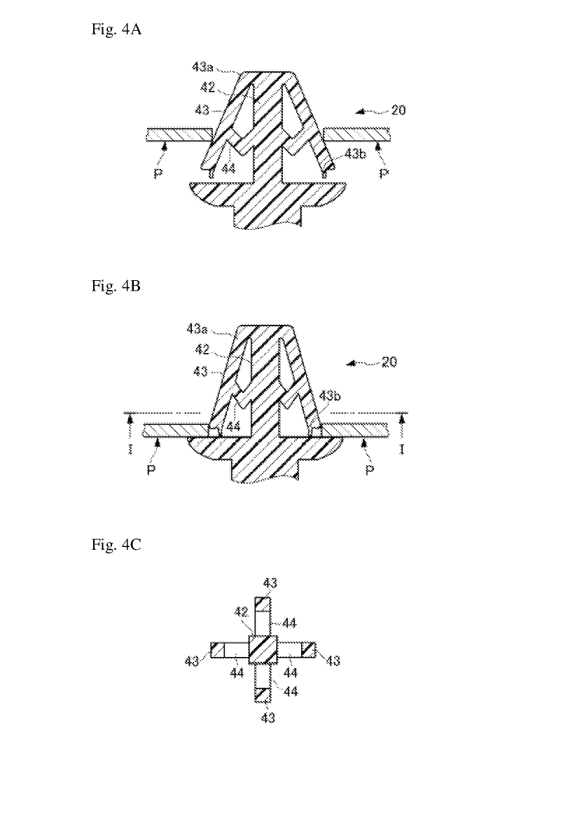

Next, a state where the clip portion 40 is fitted to lock in the vehicle body panel P is described with reference to FIGS. 4A, 4B, and 4C.

In the normal temperature state, an outer diameter of a portion near a height direction center of the inclined piece 43 is substantially equal to the diameter of the through hole 50 and touches the edge of the through hole 50 when fitting the clip portion 40, as illustrated in FIG. 4A. When fitting the clip portion 40 to the through hole 50, the second end portion 43b near the vehicle body panel P bends inward so that the inclined piece 43 passes through the through hole 50 and is locked to the edge of the through hole 50, as illustrated in FIG. 4B. FIG. 4C is a top view of cross-section I in FIG. 4B.

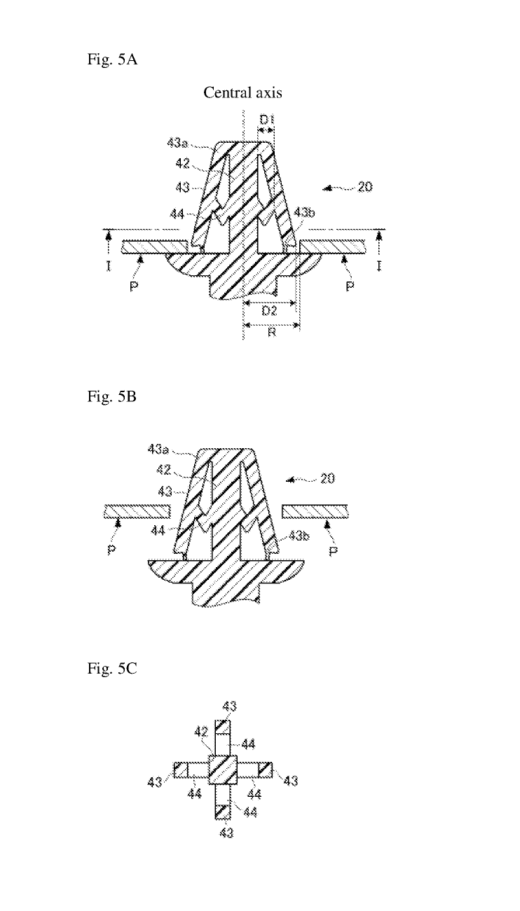

Next, a state where the clip portion 40 is removed from the vehicle body panel P is described with reference to FIGS. 5A, 5B, and 5C.

As illustrated in FIG. 5A, when removing the clip portion 40 from the through hole 50, the clip portion 40, including the connecting piece 44, is heated to the glass transition temperature and exhibits shape memory, and the connecting distance D1 becomes shorter. Although in the present embodiment the glass transition temperature is 80° C., it may be another temperature.

Specifically, the memorized shape of the clip portion 40, including the connecting piece 44, is made to contractively deform inward as compared to the shape in the normal temperature state illustrated in FIG. 1, for example, and when heated to the glass transition temperature of 80° C., a distance D2 between a lower end portion of an inclined surface of the inclined piece 43 and a central axis of the column portion 42 becomes smaller than a radius R of the through hole 50.

As a result, a distance between the lower end portion of the inclined piece 43 and the central axis of the column portion 42 reaches a size that can pass through the through hole 50, and the clip portion 40 can be easily removed without touching the through hole 50, as illustrated in FIG. 5B. FIG. 5C is a top view of cross-section I in FIG. 5B.

Although in the present embodiment the entire clip portion 40 is constituted of the shape memory resin, even in a case where only the connecting piece 44 is constituted of the shape memory resin, the connecting piece 44 contractively deforms so as to pull the inclined piece 43 inward, and the distance D2 between the lower end portion of the inclined surface of the inclined piece 43 and the central axis of the column portion 42 similarly becomes smaller than the radius R of the through hole 50, thereby enabling easy removal of the clip portion 40.

As described above, the band clip 20 according to the present embodiment includes the binding band portion 30 that binds the group of wires W, and the clip portion 40 integrally provided with the head 31 of the binding band portion 30 that locks in the through hole 50 of the vehicle body panel P. The clip portion 40 includes the flange portion 41 integrally provided with the head 31 at the position separated from the head 31 by the required distance, the flange portion 41 abutting the vehicle body panel P without passing through the through hole 50 when the clip portion 40 is locked in the through hole 50; the column portion 42 provided on the flange portion 41 and passing through the through hole 50 when the clip portion 40 is locked in the through hole 50; the four inclined pieces 43 that are inclined relative to the column portion 42 such that the first end portion 43a is fixed to the upper end of the column portion 42 and the second end portion 43b is locked in the through hole 50 when the clip portion 40 is locked in the through hole 50; and the connecting piece 44 that connects the position A of the column portion 42 near the vehicle body panel P and the position B of each inclined piece 43 near the vehicle body panel P.

Further, the band clip 20 is configured such that the clip portion 40 is constituted of the shape memory resin and acquires a memorized shape such that the connecting distance D1 between the column portion 42 and each inclined piece 43 becomes shorter than at normal temperature. When fitting the clip portion 40 to the through hole 50, the second end portion 43b near the vehicle body panel P bends so that the inclined piece 43 passes through the through hole 50 and is locked to the edge of the through hole 50. When removing the clip portion 40 from the through hole 50, the connecting piece 44 is heated to the glass transition temperature and exhibits shape memory, and the connecting distance D1 becomes shorter. Thereby, the distance D2 between the lower end portion of the inclined piece 43 and the central axis of the column portion 42 reaches a size that can pass through the through hole 50.

According to this configuration, in the band clip 20, the connecting piece 44 is heated to the glass transition temperature in the state where the inclined piece 43 is fitted in the through hole 50 of the vehicle body panel P, whereby the connecting piece 44 constituted of the shape memory resin exhibits shape memory and the connecting distance D1 between the column portion 42 and the inclined piece 43 becomes shorter. As a result, the distance D2 between the lower end portion of the inclined piece 43 and the central axis of the column portion 42 becomes smaller than the radius R of the through hole 50 and reaches a size that can pass through the through hole 50; thus, the band clip 20 can be easily removed from the through hole 50 of the vehicle body panel P. Accordingly, workability of removing the band clip 20 can be enhanced.

In addition, the connecting piece 44 can be curved in a “V” shape so as to protrude toward the flange portion 41. According to this configuration, the V-shaped connecting piece 44 is more easily deformed in a direction in which an interval between a first and second side of the connecting piece 44 narrows, and the inclined piece 43 can be displaced inward easily. Accordingly, the band clip 20 can be easily pulled out of the through hole 50 of the vehicle body panel P and the workability of removing the band clip 20 can be enhanced.

The wire harness 10 according to the present embodiment includes the group of wires W and the band clip 20, and is configured so that the group of wires W is bound by the band 33. According to this configuration, in the wire harness 10, the band clip 20 can be easily pulled out of the through hole 50 of the vehicle body panel P. Accordingly, workability of removing the band clip 20 can be enhanced.

It is noted that a technical scope of the band clip and the wire harness according to the present invention is not limited to the above-described embodiment, and includes various modifications to each component disclosed within a scope of the claimed invention.

As described above, the band clip and the wire harness according to the present invention enhance the workability of removing the band clip from the vehicle body panel, and are useful for band clips and wire harnesses in general.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. A band clip comprising:
a binding band portion configured to bind a group of electrical wires; and
a clip portion that is integrally provided on a head of the binding band portion and is configured to kick in a through hole of a vehicle body panel,
wherein the clip portion comprises:
a flange portion integrally provided with the head at a position separated from the head by a required distance, the flange portion abutting the vehicle body panel without passing through the through hole when the clip portion is locked in the through hole;
a column portion provided on the flange portion and passing through the through hole when the clip portion is locked in the through hole;
at least two inclined pieces inclined relative to the column portion such that a first end portion is fixed to an upper end of the column portion and a second end portion is locked in the through hole when the clip portion is locked in the through hole; and
a connecting piece that connects a position of the column portion near the vehicle body panel and a position of each inclined piece near the vehicle body panel,
wherein at least the connecting piece is constituted of a shape memory resin and acquires a memorized shape such that a connecting distance between the column portion and each inclined piece becomes shorter than at normal temperature,
and wherein, when fitting the clip portion to the through hole, the second end portion near the vehicle body panel bends so that each of the inclined pieces passes through the through hole and is locked to an edge of the through hole, and when removing the clip portion from the through hole, the connecting piece is heated to a glass transition temperature and exhibits shape memory, and the connecting distance becomes shorter and a distance between a lower end of the inclined piece and a central axis of the column portion reaches a size that can pass through the through hole.

2. The band clip according to claim 1, wherein the connecting piece is curved in a “V” shape so as to protrude toward the flange portion.

3. A wire harness, comprising:
a group of wires; and
the band clip according to claim 1,
wherein the group of electrical wires is bound by the band portion.

4. A wire harness comprising:
a group of wires; and
the band clip according to claim 2,
wherein the group of electrical wires is bound by the band portion.
